(19) United States
(12) Patent Application Publication
(10) Pub. No.: US 2008/0291096 A1
(43) Pub. Date: Nov. 27, 2008

(54) Cruciform Antenna Comprising Linear Sub-Antennas and Associated Processing for Airborne Radar

(76) Inventor: Jean-Marc Cortambert, Toulon (FR)

Correspondence Address: BUCHANAN, INGERSOLL & ROONEY PC, POST OFFICE BOX 1404, ALEXANDRIA, VA, 22313-1404, US

(21) Appl. No.: 11/914,665

(22) PCT Filed: May 12, 2006
(86) PCT No.: PCT/FR06/01080

§ 371 Date: Jul. 28, 2008

(30) Foreign Application Priority Data
May 16, 2005 (FR) 05/04894

(51) Int. Cl. H01Q 1/28; G01S 3/16

(52) U.S. Cl. 343/705; 342/380

(57) ABSTRACT

The invention relates to an antenna (1) including:
a first (2) and a second (3) linear sub-antenna equipped with sensors (21-2M, 31-3N) forming first and second line portions and generating a basic signal (Si′, Gj′), wherein the angle between the directional vectors of the first and second tangents to the midpoint of the first and second line portions is between 30° and 150°;
a device for transmitting an electromagnetic signal at a frequency equal to at least 10 GHz;
an antenna processing device (4, 5) forming a plurality of combined signals (VSi, VGj);
a signal processing device (6, 7) generating combined signals (TSi, TGj);
a device (8) for calculating the correlation coefficients ([Cᵢⱼ]) between the useful combined signals;
a device (8) generating a detection signal ([Rᵢⱼ]) when a correlation coefficient exceeds a predetermined threshold.

This invention relates in general to antennas, and in particular to the antenna structure and the architecture of the processing of data from sensors of such antennas when they are used for reception and transmission.

It is known in the field of radar to use surface antennas with beam-forming by calculation, intended to detect, locate and classify targets or sources. Such an antenna generally consists of an array including up to several thousand sensors arranged so as to form a rectangular planar surface. These sensors generally have an identical directivity pattern. This basic directivity pattern does not have a sufficient resolution for the performance required from the antenna in location. A beam-forming device produces a combination (for example, a linear combination) of signals generated by the sensors so as to form the required elevation angle and bearing directivities.

For example, airborne radar on a helicopter needs detection and locating performances that are not currently being satisfied, in order to detect certain targets such as high-voltage cables, pylons, or any small obstacle. For this, it would be necessary in the current state of the art, to increase the size of such an antenna, which is difficult to envisage today for various reasons including the bulk, the weight and the cost of such antennas including the devices for acquisition and processing of data from the sensors.

Such an antenna therefore has disadvantages for airborne radar. For a given precision of the location in terms of elevation angle and bearing, for example of a high-voltage pylon or cable, this antenna is very expensive and difficult to integrate on an aircraft.

Therefore, an antenna solving one or more of these disadvantages is needed. The invention therefore relates to an antenna including:
a first and a second linear sub-antenna:
   each having a plurality of electromagnetic sensors arranged so as to form first and second line portions, respectively, with each sensor generating a basic signal;
   wherein the angle between the respective directional vectors of the first and second tangents to the midpoint respectively of the first and second line portions is between 30° and 150°;
a device for transmitting an electromagnetic signal at a frequency equal to at least 10 GHz;
an antenna processing device forming a plurality of combined signals for each line portion, which signal is a combination of basic signals of the sensors of this line portion;
a signal processing device generating combined signals useful for filtering the noise of the combined signals coming from each line portion;
a device for calculating the correlation coefficients between the useful combined signals of the first line portion and the useful combined signals of the second line portion;
a device generating a detection signal when a correlation coefficient exceeds a predetermined threshold.

It is possible for the transmission device to transmit a plurality of electromagnetic beams simultaneously. It is possible for the transmission device to transmit a very wide beam in terms of elevation angle and bearing.

It is possible for the correlation coefficient calculation device to perform correlation calculations between the combined signals necessary for the first line portion and combined signals necessary for the second line portion from basic signals measured simultaneously by the electromagnetic sensors.

According to an alternative, the antenna also includes a target detection device, comparing each calculated correlation coefficient with a predefined associated threshold, detecting and locating a target when a correlation coefficient exceeds the associated threshold.

According to another alternative, the antenna includes a device for processing the detection signal and the correlation coefficients generating information concerning the target detected.

According to yet another alternative, the information generated includes the distance, the elevation, the bearing, the speed and an image of the target. According to another alternative, the antenna includes a device displaying the information generated.

It is possible for the device to display the image of the target only if another information item generated exceeds a predetermined threshold.

According to an alternative, the sensors are transmissive; the transmission device includes an excitation circuit supplying power to the sensors of the linear sub-antennas so that they transmit at a frequency equal to at least 10 GHz; the data processing device processes the combined signals according to the signal transmitted by each sensor, which processing includes, for example, a pulse compression.

According, to yet another alternative, the first and second line portions have a length between 30 and 150 cm and a width between 1 and 10 cm.

The invention also relates to an aircraft including an antenna as described above, wherein the first and second line portions are substantially straight and form substantially a V of which the base is oriented toward the top of the aircraft. According to an alternative, the vectors directing the first and second line portions have an angle of between 40° and 50° with respect to the vertical of the aircraft.

Other special features and advantages of the invention will become clearer from the following description given by way of a non-limiting example, with regard to the figures. These figures show:

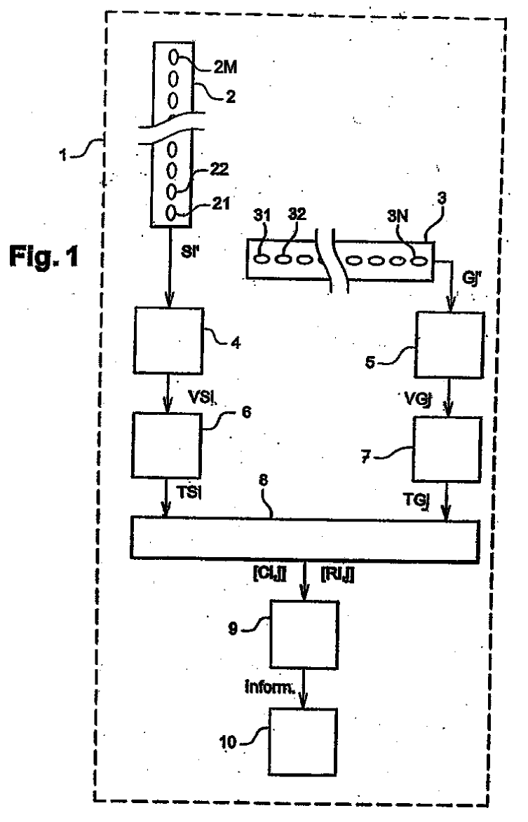

FIG. 1, a diagrammatic representation of an example of antenna structure and architecture for processing data from sensors of such antennas according to the invention;

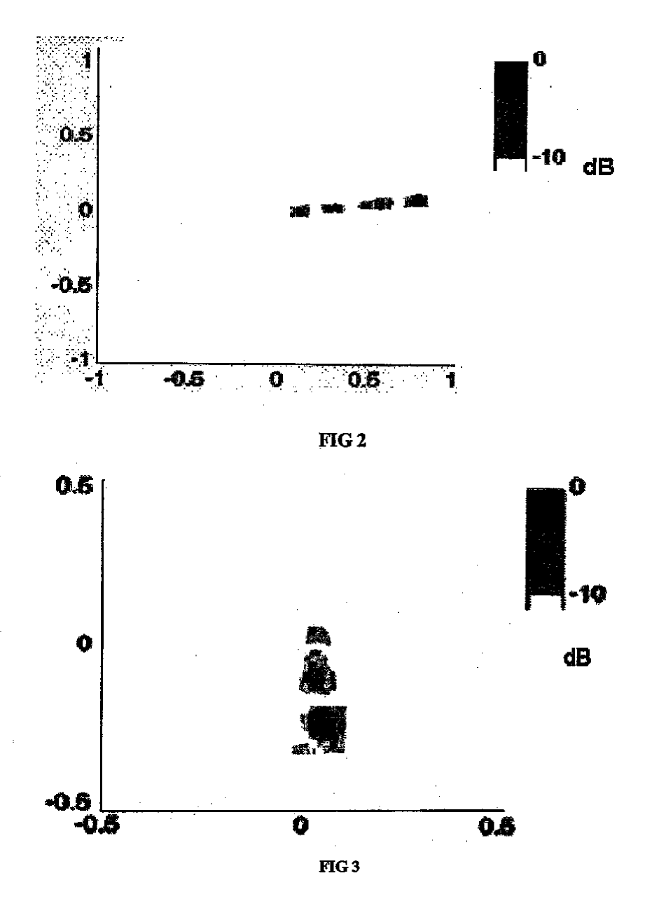

FIGS. 2 and 3, examples of location diagrams in various cases.

The term sensor hereinafter refers to a device including one or more elementary sensors. A sensor having a plurality of elementary sensors generates a basic signal based on the elementary sensor signals in a manner known per se.

To improve the performance of a sensor, it is commonplace to use a module combining a plurality of sensors. The term sensor used in this document also covers a module of sensors, because a sensor and a module of sensors are functionally identical for the antenna processing.

The term antenna processing hereinafter refers to the processing of signal of sensors, which forms, by combining the sensor signals, signals called channels or beams, which favor a direction of travel in the space of the physical quantity. The signal combinations mentioned below will be, for example, linear combinations of these signals.

The term transmission frequency hereinafter refers to a transmission frequency for which the transmission power is greater than 20 dB with respect to the ambient noise.

The invention proposes an antenna including at least two linear sub-antennas, each equipped with electromagnetic sensors forming a line portion. The two line portions are defined as follows: tangents to the midpoint of each line portion are formed. The angle between directional vectors of these tangents must then be between 30° and 150°. The orientations of the line portions are thus distinct enough for the antenna to recover sufficient information along two distinct axes considered to be orthogonal. The antenna also includes a device for transmitting an electromagnetic signal at a frequency equal to at least 10 GHz. Each of the linear sub-antennas has an antenna processing device that generates one or more combined signals. Each of the linear sub-antennas has a signal processing device applied to the combined signals, which provides one or more useful combined signals. These useful combined signals are the results of the processing of the combined signals, intended to extract the noise therefrom, and are generated before the correlation processing. The antenna also has a device for calculating the correlation coefficients between the useful combined signals of one linear sub-antenna with the useful combined signals of the other linear sub-antenna. The resolution information is obtained by calculation rather than by increasing the number of sensors.

It is possible for the sensors of the sub-antennas to be transmissive and excited by the transmission device. It is also possible to provide distinct transmission members for the sensors of the sub-antennas.

It is possible for the first and second line portions respectively to have the direction of the axis or of the vertical of the aircraft. It is also possible for the first and second line portions to be inclined with respect to the vertical of the aircraft. For example, the first and second line portions can be inclined by an angle of 45° with respect to the vertical, with the two sub-antennas forming a V. This configuration is beneficial for minimizing the effects of the clutter on the likelihood of a false alarm of the radar.

A simplified example of an antenna will be described in reference to FIG. 1. The antenna of FIG. 1 includes two linear sub-antennas 2 and 3. The linear sub-antennas 2 and 3 each include a plurality of sensors, respectively 21 to 2M and 31 to 3N. Sensors 21 to 2M are arranged so as to substantially form a first line portion. Sensors 31 to 3N are arranged so as to substantially form a second line portion.

The first and second line portions of FIG. 1 verify the orientation condition defined previously: these line portions are in this case straight segments placed in the same plane and are orthogonal. The angle between the directional vectors can be in an appropriate range selected by a person skilled in the art. It is also possible for this angle to be in the following ranges: [40°; 140°], [50°; 130°], [60°; 120°], 70°; 110°], [80°; 100°], [85°; 95°], or [89°; 91°]. Sensors 21 to 2M are in this case used to determine the elevation angle of a source or a target, while sensors 31 to 3N are used to determine the bearing thereof.

These sensors include one or more elementary sensors not shown, of the appropriate type. A sensor having one or more elementary sensors generates a basic signal based on elementary sensor signals in a manner that is known per se. Each sensor therefore generates a basic signal that can undergo a particular signal processing operation before the antenna processing. The sensors of a line portion can have an identical directivity and be equally distributed on this line portion. Sensors 21 to 2M respectively generate basic signals S1 to SM illustrated by Si′. Sensors 31 to 3N respectively generate basic signals G1 to GN illustrated by Gj′. The symbol i′ will hereinafter be used to designate all of the signals or numbers associated with a sensor 2i′. Thus, signal S4 is associated with sensor 24. Similarly, the symbol j′ will be used to designate all of the signals or numbers associated with a sensor 3j′. Thus, signal G2 is associated with sensor 32.

An antenna processing device 4 forms a combined signal of the sensors of a line portion, in a manner that is known per se. The antenna processing device 4 thus generates the combined signals VSi associated with the signals Si′. An antenna processing device 5 forms a combined signal of the sensors of the other line portion, in a manner that is known per se. The antenna processing device 5 thus generates the combined signals VGj associated with the signals Gj′. The combined signals are intended, inter alia, to form directivity lobes of the antenna used for reception.

Each of the linear sub-antennas has a signal processing device processing signals coming from the antenna processing. This signal processing device provides one or more useful combined signals at the output of each linear sub-antenna.

The signal processing devices 6 and 7 extract the useful signal from the noise, in a manner that is known per se. Devices 6 and 7 thus respectively process the combined signals VSi and VGj in order to generate useful combined signals-TSi and TGj. Signal processing devices 6 and 7 can also be coupled to the transmission device of the antenna, not discussed in detail here, so as to perform a processing operation taking into account the signals transmitted in a manner that is known per se, such as pulse compression.

The calculation device 8 calculates the time or frequency correlation coefficients (depending on whether the processing was performed in the time or the frequency domain) between the useful combined signals TSi of the first line portion and the useful combined signals TGj of the second line portion. Thus, the matrix [Cij] of correlation coefficients is thus formed. Details regarding the calculation of these coefficients will be provided below. The calculation device 8 also uses correlation coefficients [Cij] to detect a target and generate a detection signal. A possible operation is as follows: a detection device (included in the calculation device 8 in the example) compares each correlation coefficient with a respective predefined threshold. When a given correlation coefficient is below its predefined threshold, it is considered that there is no source or target located at the intersection of the two directivity lobes VSi and VGj, in the elevation angle i and the bearing j. When a correlation coefficient exceeds its predefined threshold, however, it is considered that a source or target is located at the intersection of the two directivity lobes, in the elevation angle i and the bearing j. A detection signal associated with the result of the comparison can thus be generated in the form of a binary value. All of the signals can then be arranged in a matrix [Rij]. The threshold is defined according to the desired performance of the antenna and the associated data processing device (including the antenna processing, the signal processing and the information processing), in terms of probability of detection and false alarms.

In the case of antenna processing operations known to a person skilled in the art, With the antenna of FIG. 1 being of the transmission/reception type, the directivity diagram at the transmission of the antenna is that of a lobe in the form of a cross, and, by reciprocity, the directivity diagram at the reception is the same as at the transmission. With the antenna structure presented, the association of the antenna and signal processing operations makes it possible to obtain the same information as that obtained by a surface antenna, for example, a planar antenna, of which the directivity lobe at the reception would be as thin as the centre of the cross formed by the directivity lobe. In addition, also in the case of antenna processing operations known to a person skilled in the art, if the antenna of FIG. 1 does not perform the correlation processing between the signals coming from the linear sub-antennas, the detection performance is equivalent to that of sub-antennas alone. This performance is clearly inferior to that obtained by the antenna of the invention.

The processing device 9 can perform additional information processing steps, in order to improve, for example, the performance with regard to the probability of false alarms or in order to determine the speed, the distance or the image of a target or any other useful information. The processing device 9 is thus intended to enable the information to be processed by an operator or a processing device. This device 9 receives, at the input, data such as the matrix [Cij], the matrix [Rij] or any similar data. All of the information determined can be provided to the users by an appropriate display device 10, which is known per se. The display device can in particular display the time before collision, merge the image of the target with another information item generated (for example the distance or the speed of the target), hierarchically select the targets and selectively present them on a screen.

It is possible to use various limitations regarding the form of the line portions. In particular, it is possible for at least one line portion to have a curved form. It is possible for such a curve not to have an inflection point. It is also possible for the variation in curvature to be limited.

It is thus possible to limit the curvature near the midpoint of the line portion. The length of the line portion L and the curvilinear distance d between a point and the midpoint of the line portion are defined. For any point such as d/L<0.1, it is possible for the angle between a directional vector of the tangent at this point and a directional vector of the tangent to the midpoint not to be included in the range [45°; 135°].

It is possible for a line portion to be conformal, i.e. for it to have a form matching the non-rectilinear form of its support, and for a processing of the signals of the modules to make this line portion equivalent to a rectilinear line portion. It is in particular possible to apply such a processing operation to a line portion attached to the surface of the keelson, a wing or a tail unit of an airplane. The processing of conformal antennas is a technique known to a person skilled in the art.

The two line portions can be separated by any distance on the condition that the target or the source is in the far field of the two sub-antennas, which is defined by a person skilled in the art for each sub-antenna as the ratio of the square of the rectilinear length of the antenna to the lowest wavelength used by the antenna.

The two line portions can be arranged at a sufficient distance separating them so that a coupling between their sensors would be weak. However, the two line portions can be secants; there can be:
one sensor common to the two line portions: this means that the correlation coefficient for this sensor is reduced to its autocorrelation coefficient;
a hole in one of the two line portions: this case corresponds to gap antennas, which are known per se to a person skilled in the art.

Although only these types of antennas have been shown in the various figures, it is also possible to apply an antenna having a sensor array, for example with a rectangular shape, to the invention. The array is then divided into portions of sub-antennas as defined above. It is possible in particular to define a plurality of lines and columns and to calculate the correlation coefficients for a plurality of line-column pairs. It is also possible to consider more than two sub-antenna portions having orientations as defined above and not forming an array, and to calculate correlation coefficients for a plurality of pairs of these sub-antenna portions. The calculations of the correlation coefficients for various pairs can be crossed to enhance the performance of the antenna.

In an application of the antenna to a radar, an antenna is used for reception and the sensors of the modules are suitable for detecting radar signals. The processing device forming the combined signal in particular performs a beam-forming function.

To perform the calculation of the time correlation coefficient of complex video signals (for example, TSi and TGj in the example of FIG. 1), particularly suitable for a radar application, the coefficients of [Cij] can be calculated as follows:

Let X(t) and Y(t) be complex, random, non-periodic, centered and stationary signals of the second order. The correlation function of the two signals is defined as the mathematical expectation of the product of X(t) by the conjugated complex of Y(t−τ), τ being the time shift between the two signals.

correlation_{xy}(τ)=E[X(t)Y*(t−τ)]=┌_{Ω}x(t,ω)Y*(t−τ,ω)dP(ω)

In the case of ergodic signals, the correlation function verifies the following equation:

$${correlation}_{XY} ( τ ) = {lim}_{T -> ∞} \frac{1}{2 T} {\int }_{- T}^{+ T} X ( t ) {Y}^{*} ( t - τ ) d t$$

In practice, the integral is calculated over a finite time interval that corresponds to the integration time.

A person skilled in the art will know to adapt the formulas to the cases of periodic signals, unscented or not verifying all of the statistical properties cited above.

The normalized correlation function between the two signals is defined as follows:

$${C}_{XY} ( τ ) = \frac{{corr é lation}_{XY} ( τ )}{\sqrt{{corr é lation}_{XX} ( 0 )} \sqrt{{corr é lation}_{YY} ( 0 )}}$$

The use of normalized correlation coefficients makes it possible to detect a target without being concerned about the differences in levels between X and Y.

Because the correlation function moves toward zero when τ moves toward infinity, it is considered in practice that the time shift τ is bounded. For example, if τ is between the time interval [−τ max, τ max], then there is a value τ₀ of τ for which the normalized correlation function reaches its maximum C_{xy}, the maximum correlation function between the two linear sub-antennas.

C_{xy}=|C_{xy}(τ=τ₀)|=max_{[-τ}_{ₘₐₓ}_{,τ}_{ₘₐₓ}_{]}[|C_{xy}(τ)|]

The time shift τ₀ is determined by the shape of the antenna. In the case of two identical linear sub-antennas that are secants at their centre, the maximum C_{xy} is reached for τ₀=0.

The maximum correlation coefficients Cij are obtained by replacing the random signals X(t) and Y(t) with the useful combined signals as defined above TSi and TGj. The correlation coefficients Cij therefore form a matrix [Cij] of which the values are between 0 and 1.

A maximum correlation coefficient value Cij above a predefined correlation threshold means that at least one source or one target is detected at the virtual intersection of the directivity lobes of the two linear sub-antennas 2i and 3j. In the case of FIG. 1, the presence of a source or target is determined at the intersection of the elevation angle i and the bearing j.

Another calculation method, based on the use of real combined signals, makes it possible to simplify the calculation step. The correlation coefficients are then determined, by considering the correlation function in the following way:

$${correlation}_{X , Y} ( τ ) = \frac{1}{2} ( E [ {\vert X ( t ) + Y ( t - τ ) \vert}^{2} ] - E [ {\vert X ( t ) \vert}^{2} ] - E [ {\vert Y ( t ) \vert}^{2} ] )$$

$$Or$$

$${correlation}_{X , Y} ( τ ) = \frac{1}{4} ( E [ {\vert X ( t ) + Y ( t - τ ) \vert}^{2} ] - E [ {\vert X ( t ) - Y ( t - τ ) \vert}^{2} ] )$$

This method makes it possible to obtain correlation coefficients directly from the signal strengths by simply performing addition or subtraction operations.

In addition, it is possible to consider excluding signals that are too weak from the detection. Thus, it is possible to first calculate the denominator of the normalized correlation function mentioned above, and to compare it with a minimum threshold. When the denominator of the normalized correlation function is smaller than the minimum threshold, the corresponding correlation coefficient is not taken into account for the detection, which amounts to giving it a zero value. It is also possible to significantly reduce the integration time necessary for similar performances. Alternatively, it is also possible to compare each threshold of the denominator to a respective threshold.

To ensure an optimal result, it is desirable for the acquisition of the signals used for the correlation calculation to be synchronous.

Although a correlation calculation solution has been described in the time domain, it is also possible to consider calculating correlation coefficients in the frequency domain, for example for an application in a sonar. The correlation coefficients in the frequency domain can be determined from the coherence function defined as follows.

The Fourier transforms of the correlation functions of two signals X and Y defined above are inter-spectral densities (or interaction spectral densities).

Fourier transform(correlation_{xyy})(f)=S_{xy}(f)

Similarly, the Fourier transforms of the correlation functions of signals X and Y defined above are power spectral densities of signals X and Y.

Fourier transform(correlationₓₓ)(f)=Sₓₓ(f)

Fourier transform(correlation_{yy})(f)=S_{yy}(f)

The coherence function between X and Y is defined by:

$${c}_{XY} ( f ) = {coherence}_{XY} ( f ) = \frac{{S}_{XY} ( f )}{\sqrt{{S}_{XX} ( f )} \sqrt{{S}_{YY} ( f )}}$$

The calculation of the coherence coefficients is generalized for all frequency bands of analysis B_{f}. In this case, the calculation of the coherence function becomes:

$${c}_{XY} ( f ) = {coherence}_{XY} ( {B}_{f} ) = \frac{{\int }_{{B}_{f}} {S}_{XY} ( f ) d f}{\sqrt{{\int }_{{B}_{f}} {S}_{XX} ( f ) d f} \sqrt{{\int }_{{B}_{f}} {S}_{YY} ( f ) d f}}$$

It is possible for the antenna processing devices 4 and 5 to weigh the basic signals of the sensors according to differences in directivity or sensitivity, before performing the combination (for example, linear) of these signals.

The antenna processing devices can also include an adaptive processing, which is intended to eliminate a parasitic signal, such as that coming from a jammer or any other processing enabling the functionalities and performances of the antenna and the associated data processing to be improved.

The signal processing devices 6 and 7 for the combined signals can perform: bandpass filtering, Doppler or MTI filtering, pulse compression processing operations or angle-error measurements or any other processing operation enabling the functionalities and performances of the antenna and the associated data processing to be improved.

Although not shown, it is possible for the antenna to include suitable data processing stages, providing the appropriate information to the operators. In general, the calculation of the correlation coefficients will preferably be performed after an antenna processing step and a signal processing step. The calculation of the correlation coefficients will generally be followed by a thresholding and information processing step.

The information processing stages, corresponding to the devices 8 to 10 in FIG. 1, are intended, for example, to detect, locate or display the presence of a source or target.

In the case of discrete signals, the calculation of the correlation coefficients can be performed on a number N of useful combined signal samples. A person skilled in the art will determine the number of samples necessary according to the desired probabilities of detection and false alarms.

For example, in the time domains N time samples of complex signals X and Y are considered, and it is hypothesized that the maximum C_{xy} is reached for τ₀=0.

$${C}_{XY} = \frac{\vert {\sum }_{t = 1}^{N} X ( t ) , {Y}^{*} ( t ) \vert}{\sqrt{{\sum }_{t = 1}^{N} {\vert X ( t ) \vert}^{2}} \cdot \sqrt{{\sum }_{t = 1}^{N} {\vert Y ( t ) \vert}^{2}}}$$

If the signals that are too weak are eliminated by performing a test on the denominator as described above, then the number of samples N can be significantly reduced for similar performances with regard to the probability of false alarms and detection.

To detect a metallic cable with a diameter of 1 cm at a distance of 1000 meters from an aircraft, the following rules for dimensioning of the antenna can be used:
It is assumed that the equivalent SER surface with a 1 cm radius cable 1,000 m away is on the order of the m².
It is desirable to obtain an angle of opening 2θ³ of the main lobe at 3 dB equal to 1°, with a rejection of the secondary lobes on the order of 30 dB.
The formula 2θ³=60°λ/h is used, in which h is the vertical dimension of the antenna.
It is deduced that h=60λ, i.e. a height of 60 cm (the sub-antennas are oriented respectively according to a vertical and a horizontal of the aircraft). If the antenna is spatially sampled at λ/2, the antenna must be constituted by around 120 sensors.
It is assumed that only the horizontal sub-antenna is used on transmission in order to minimize the effect of the ground clutter. A bearing scan is thus performed.
On transmission, only a 32° elevation angle sector must be monitored; it is necessary also to take into account more than 5 dB of transmit gain.
It is assumed that 32° of bearing are monitored, i.e. 32 beam positions of 1°.
Each beam is therefore illuminated for: 1250 μs.
With the same radar recurrence: Tr=14 μs, the number of pulses integrated is now equal to 90.
The horizontal sub-antenna with 120 transmitters of 1 W each therefore transmits a power of 120 Watts.

Comparative trials and studies have been performed. The antenna according to the invention has two perpendicular straight line portions each consisting of 120 modules, i.e. a total of 240 modules. The antenna has a transmission frequency of 35 GHz and each sub-antenna has a substantially rectangular shape. Each sub-antenna has a length of 50 cm and a width of 3 cm. The sub-antennas have been arranged on an aircraft to form an inverted V (the base of the V being oriented toward the top of the aircraft) in order to minimize the clutter effects. The antenna makes it possible to detect a SER (surface equivalent radar) cable on the order of −30 dB at a distance of some hundred meters for a non-specular detection of the cable. Tests have been conducted with transmissive sensors with an average power of 1 Watt on transmission and for a false alarm rate better than one false alarm per flight hour. The angular resolution of such an antenna is around 1% in elevation angle and bearing. The antenna of the invention has an adequate resolution for identifying the high-voltage cables and pylons, as shown respectively in the diagrams of FIGS. 2 and 3, obtained from simulations.

The method for testing the denominator of the correlation coefficient has made it possible in practice to increase the detection distance of a cable with respect to a reference antenna by 30%.

The tilt of the linear sub-antennas, for example by 45° with respect to their initial vertical (and respectively horizontal) axis, also makes it possible to reduce the influence of the ground clutter on the detection and false alarms.

1. Antenna (1) characterized in that it includes:
a first (2) and a second (3) linear sub-antenna:
each having a plurality of electromagnetic sensors (21-2M, 31-3N) arranged so as to form first and second line portions, respectively, with each sensor generating a basic signal (Si′, Gj′);
wherein the angle between the respective directional vectors of the first and second tangents to the midpoint respectively of the first and second line portions is between 30° and 150°;
a device for transmitting an electromagnetic signal at a frequency equal to at least 10 GHz;
an antenna processing device (4, 5) forming a plurality of combined signals (VSi, VGj) for each line portion, which signal is a combination of basic signals of the sensors of this line portion;
a signal processing device (6, 7) generating combined signals (TSi, TGj) useful for filtering the noise of the combined signals coming from each line portion;
a device (8) for calculating the correlation coefficients ([Cij]) between the useful combined signals of the first line portion and the useful combined signals of the second line portion;
a device (8) generating a detection signal ([Rij]) when a correlation coefficient exceeds a predetermined threshold.

2. Antenna according to claim 1, characterized in that it also includes a target detection device, comparing each calculated correlation coefficient with a predefined associated threshold, detecting and locating a target when a correlation coefficient exceeds said threshold.

3. Antenna according to claim 2, characterized in that it includes a processing device (9) for processing the detection signal and the correlation coefficients generating information concerning the target detected.

4. Antenna according to claim 3, characterized in that the information generated includes the distance, the elevation angle, the bearing, the speed and an image of the target.

5. Antenna according to claim 3 or 4, characterized in that it includes a device (10) displaying the information generated.

6. Antenna according to claims 4 and 5, characterized in that the device (10) displays the image of the target only if another information item generated exceeds a predetermined threshold.

7. Antenna according to any one of the previous claims, characterized in that:
the sensors are transmissive;
the transmission device includes an excitation circuit supplying power to the sensors of the linear sub-antennas so that they transmit at a frequency equal to at least 10 GHz;
data processing device processes the combined signals according to the signal transmitted by each sensor, which processing includes, for example, a pulse compression.

8. Antenna according to any one of the previous claims, characterized in that the first and second line portions have a length between 30 and 150 cm and a width between 1 and 10 cm.

9. Aircraft including an antenna according to any one of the previous claims, characterized in that the first and second line portions are substantially straight and form substantially a V of which the base is oriented toward the top of the aircraft.

10. Aircraft according to claim 9, characterized in that the vectors directing the first and second line portions have an angle of between 40° and 50° with respect to the vertical of the aircraft.
